(19) United States
(12) Patent Application Publication
(10) Pub. No.: US 2019/0129602 A1
(43) Pub. Date: May 2, 2019

(54) SYSTEMS AND METHODS FOR IMAGING GROUNDING

(71) Applicant: Greg Siwak, Clayton, MO (US)

(72) Inventor: Greg Siwak, Clayton, MO (US)

(21) Appl. No.: 16/173,559

(22) Filed: Oct. 29, 2018

Related U.S. Application Data
(60) Provisional application No. 62/577,971, filed on Oct. 27, 2017.

(51) Int. Cl. G06F 3/0484; G06F 3/0488

(52) U.S. Cl. CPC G06F 3/04845; G06T 19/003; G06F 3/04886

(57) ABSTRACT

A system and method for image grounding which can be used when navigating a sub-image within a larger image or collection of images. Specifically, the system and method utilizes an artificial horizon generated for a larger image and the component sub-image image within the image “drifts” toward the artificial horizon in circumstances where confusion as to position ma have occurred. The drift will commonly activate when a user ceases active navigation through the image but may occur in other embodiments when a situation occurs which could indicate confusion about location within the image or on demand.

### CROSS REFERENCE TO RELATED APPLICATION(S)

This application claims the benefit of U.S. Provisional Application Ser. No. 67/577,971, filed Oct. 27, 2017 the entire disclosure of which is herein incorporated by reference.

### BACKGROUND OF THE INVENTION

### 1. Field of the Invention

This disclosure is related to the field of image processing, and more specifically to processint:t the viewing of a sub-image within internal navigation of a larger image such as when the image is zoomed-in.

### 2. Description of the Related Art

The commonality of cameras in today's world has changed humans interaction with images. It is rare now for a newsworthy event to occur without there being a first person video available from someone who shot it on a personal smar hone or related device. Similarly, the pervasiveness of cameras is also reducing belief in phenomena such as UFO visitation due to lack of evidence beinu generated.

The commonality of the camera, however, would not have necessarily resulted in these changes had it also not come with the pervasiveness of digital imagery in those cameras. Digital imaging, and particularly High Definition (or HD) digital imaging, has dramatically changed the way that images can get used. Originally, a photo could only tell information that could be seen from the photo and was relatively hard to distribute. While images could be made larger, they would often get'very grainy and details Were hard to see as the definition of the camera Was below that of the human eye. Further, traditional print images were limited in size and shape to available printer capability and required developing which took time (even in the day where there was a 1-hour photo developer on every street corner) and resources resulting in relatively few copies.

Digital imagery has changed that as it is now possible to record with a camera or other imager an imagt. with More detail than the hunian eye um resolve and to use, reuse, and transfer the image in near limitless fashiot. As such, viewing within an image (“zooming-in”) has become commonplace. Easily accessible smanphones allow a user to zoom in and out of images they take to see hidden details and utilize imagery in ways that previously were not even possible, much less so accessible.

With the advent of imagers that can record more information than the human eye can see, images can and are being used in different ways than was ever possible for printed images. One of the most pervasive of these is the use of sub-images within an image. It is now possible to record an image with a field of view that is greater than the field of view of a human observer, and the human observer can then navigate through that larger image viewing any subsection of it to see everything that is recorded as if they are navigating through the space that original image represents,

Field of view, in it's most basic form, is the extent to which a human being, or any other optical device, can see the world. A human's eyes are on the front of their head and provide humans with excellent depth perception by providing a narrower total field of view of around 160 degrees, but with a large percentage (around 115 degrees) of that area being telescopic view (the area seen by both eyes which resolves greater depth). However, this biological construction means that a human being cannot see something behind their head, and cannot see well to their side. Instead, they have to turn their eyes and or head to see in such a fashion.

Because of humans' limited total field of view, humans, from a relatively early age, understand that objects still exist even when they cannot see or perceive them because we understand that our perception is limited by our field of view. We know the back of the chair is still their even when we are not touching it and are facing forward. This is because we saw it previously and know that it does not disappear when it is not in view. We understand this because humans are built, and learn, to recognize that our field of view is limited.

It has long been recognized that the human field of view, however, is not the only one. From biological studies we are well aware that many animals see in a much different Way to humans. For example, many birds and fish have a much larger basic field of view, but a smaller telescopic one as this can allow them to better detect approaching predators. Similarly, many insects utilize totally different types of view which can be though to assist in their survival.

One of the major things that cameras and other forms of imagers possess is the ability to utilize specialized lenses (or multiple lens using methods such as image stitching) that can see in different ways. These often provide fields of view that are dramatically different and greater than human eyes. While a good majority of camera lensing systems typically simulate what is seen by the human operator using the camera and without moving their head, specialized lenses, such as the “fish eye” lens, and the ability to such multiple images together from interlinked imagery (such as the panoramic option common in some smartphones) can provide views simply unobtainable by human eyes.

As these types of imagers allow for the capture of much more information than a human can see, they are very useful, in a variety of industries. For example, wide fields of view can be very useful in security systems as they can monitor areas that humans cannot see into and can monitor larger spaces than a single human could ever hope to monitor without aid. Similarly, camera probes can often see large amounts of structure as they move through an area without having to rotate. This can enable, for example, minimally invasive medical examination and procedures on some of the smallest (and hardest to access) parts of the human body.

These types of imagers, however, because of the nature of the image they capture, often generate images which are basically not compatible with human vision and not readily presented in a human viewable format. In much the same way seeing through a lens how a housefly “sees” does not really allow us to understand how a housefly reacts to this intbrmation, it is very difficult for a human to view the output of a camera looking around their head 360 degrees at all times (viewing an image with a greater than 180 degree vertical field of view and 360 degree horizontal field of view) or otherwise presenting information which we are simply biologically not designed to obtain. The image presented by such a vide-angle camera cannot be viewed in native format as a human's eyes simply cannot view it that way (or eyes would need to correspond to the camera lens, which they do not) and instead it is commonly presented in a format suitable for human vision with a field of view of less than half what was used to record it. This often results in a the view which is distorted. It may be distorted by either modifying the actual image to correspond to the medium (for example, by having to shrink relative dimensions) or by having to take changes to make the medium better correspond to the image.

A good example of the problem is ancient. The need to present the surface of the Earth (which is generally spherical) on a flat map results in either distances being inaccurately presented at an increasing rate as one approaches the poles, or, presenting a map with large gaps or;holes which are also not present. Even if distortion can be resolved as in the cases above, the image often still has to be presented in a way that goes against the way humans are used to processing information. For example, presenting a 360 view around the head in a flat circle provides the most valuable int rmation on the periphery, but humans generally have trouble perceiving details on the periphery as our telescopic vision is best at the center. It is, therefore, difficult for humans to interpret and use the output of such imagers unless they have been specifically trained to do so.

Because the human eye, and ultimately the brain, can have so much trouble interpreting these images because they are effectively “alien” due to them having a field of view which simply does not correspond to human vision, the images are often modified to help assist a human viewer in understanding the image by simply not providing all the information but only that most relevant to the task at hand. As discussed in the map scenario above, the fiat map often distorts distance toward the poles because those distances are not as necessary in navigation as those toward the equator. Where more navigation occurs. In reality, the limitation of presentation to more valuable information often takes the form of presenting only a part of the image in a specific way to make it better correspond to human vision. Generally, this occurs by breaking the image up into pieces, where each piece better corresponds to the field of view of human vision and represents what is valuable at any time. These sub-images can then be presented in a fashion where only those with valuable information are provided at any time. For example, the flat map can be broken up into hundreds of smaller map pages where each has relatively little distortion as the area of the earth presented is much smaller, and therefore “flatter” compared to the earth as a whole. Alternatively, with modern technology the image can be presented in a format which corresponds to our physical manner of altering, our field of view. The later is effectively what is done in traditional movie film as well as more recently virtual reality systems.

In many respects, all virtual reality does is to have a source image which is an image in the form of a hemisphere of images which effectively “surrounds” the user. The user is then given an imager (e.g. a pair of googles) which presents a portion of a larger image that corresponds to a human's field of view. The imager selects the portion of the hemisphere image to display based on how the user's head is positioned. (physical reorientation) and which portion of the total image would be in a. human field of view given that position. In this way, the image is presented “piece-meal” to the user to correspond with what they would expect to see. It is best to think about it as a real world example. A user can “virtually” stand on the top of the Empire State Building by simply giving the user an imager and having it show an image, corresponding to what a user standing in the same position as this user, but on the top of the Empire State Building, would be seeing. When the user moves, the sub-image displayed also moves to provide a different image.

In presenting the above, if the underlying image the user is seeing is previously recorded and static, the user is effectively navigating within the image as they turn their head. Virtual reality works, particularly with no live video, because human perception and our recognized physical limitation of movement are both coordinated. Thus, the human cannot detect that the reality is virtual because their visual input from the imager is the same as what they would see if the image was “reality” as the portion of the image presented is connected to physical rtmovement of the user.

One thing to keep in mind, however, is that the illusion in traditional virtual reality works because the user is limited in their field of view based on the position of their head. That is, the physical movement to alter position of their head is what results in the image change. To deal with this, virtual reality systems have required goggles that provide a natural field of view to be attached to and move with the user's head. Therefore, any change to the human s expected field of vision based on the movement of their head (which necessarily relates to movement of the eyes and therefore change in what is within the field of view) is readily detected and the image is adjusted to correspond simultaneously. However, a sub-image within an image type presentation still has a lot of use even if one is not interested in an immersive environment as it still allows for human analysis of a large detailed image in pieces.

Eliminating the need to move the display with the head, it is possible to allow, a user to obtain additional information from the image over time by navigating within the. image by using a viewer without being immersed in the image in a virtual reality experience. In this case, a display can be provided where the image on it can be moved around by hand, or where the viewer can be moved around to navigate within the larger image. To correspond to field of view, the image presented on the viewer is often a sub-image of the larger image corresponding to a particular field of view within the image based on the user's navigation controls.

As opposed to simulating the entire view of the human eyes as in virtual reality, this type of presentation uses the display device to represent a limited aperture into a larger image, in more common parlance, the image has been “zoomed-in” to simply show the portion selected, The user can then navigate within the image by moving the zooming device e.g. the imager) and image relative to each other. This could be considered akin to moving a slide (image) under a microscope (imager) (or vice versa). The sub-image is presented based on how the slide and aperture move relative to each other, not how the user moves relative to either. As opposed to this microscope example, however, when a digital device is presenting a portion of an image stored on, it (as opposed to on a physical slide) the user has no physical connection to the absolute relative position of the viewing device or image because there actually is no physical image while there is a physical slide.

When using a viewing device which is not rigidly locked into position with the head, the user can navigate within the image not only by physically moving the imager (e.g. panning the screen around), but also by manipulating the image on the device (e.g. scrolling). One problem with either of these types of viewing, however, is that it can be disorienting as the user lacks the physical position change of the image (as the image has no physical existence) corresponding to the image position change. Anyone who has used a microscope can understand that it, is often difficult to know where in a slide one is looking without occasionally pulling back from the eyepiece and looking at the slide. This reconnects the, physical position of the slide and lens (and, thus, the magnified image to the portion of the sample on the slide). When using a digital display, however, to view a digital image, there is no ability to step away from eyepiece and look at the physical connection to locate the displayed sub-image within the larger image because no such physical connection exists. The only option is to “zoom-out”.

Disorientation from viewing a sub-image within a larger image can be particularly problematic if the imager imaging within the larger image passes over a threshold position within the image which would normally require movement of the body to view Thus, disorientation can be very common when viewing an image with a field of view outside that of human vision. For example, if one rs vviewing a hemisphere image from inside, it can often be disorienting to go over the apex of the image as the image effectively goes from right side up to upside down (or vice versa) at that point and the user has no physical movement corresponding. Thus, any perceived physical connection the user had to the image may be broken.

In sum, in navigation with a digital image, a user has no static physical tie to the position of the imager “within” the image and is solely reliant upon the dynamic prior movement of the imager to determine the location within the image. This can result in disorientation of the user as to their position within the image.

In many situations where imagery with a greater field of view is used, it is used because it provides more information than a human can naturally see. Thus, it is often used in situations where the human using it needs to act on the information quickly. For example, 360 degree cameras can be useful in security, but a human user needs to quickly detect the possible threat within the image. 360 degree cameras can also be useful in areas such as collision avoidance or navigation where similar issues arise and in collecting information about the surroundings as an imager navigates a path. For example, the later can be very valuable to analyze the inside of a small pipe for fractures in any surface. In all these situations, however, a user which becomes disorientated can miss valuable information, or be unable to position it relative to the imager.

### SUMMARY

The following is a summary of the invention in order to provide a basic understanding of some aspects of the invention. This summary is not intended, to identify key or critical elements of the invention or to delineate the scope of the invention. The sole purpose of this section is to present some concepts of the invention in a simplified form as a prelude to the more detailed description that is presented later.

Because of these and other problems in the art, described herein is a system and method for image grounding which can be used when navigating a sub-image within a larger image or collection of images. Specifically, the system and method utilizes an artificial horizon generated for a larger image and the component sub-tmage image within the image “drifts” toward the artificial horizon in circumstances where confusion as to position may have occurred. The drift will commonly activate when a user ceases active navigation through the image but may occur in other embodiments when a situation occurs hich could indicate confusion about location within the image or on demand.

Described herein, among other things, is a method for assisting with navigation within an image, the method comprising: providing a viewer having a display; providing an initial image; defining a horizon in the initial image; displaying on the display a first sub-image which comprises a portion of the initial image; and from the first sub-image, altering the display to display a second sub-image, the second sub-image being in contact with the horizon, the altering involving an appearance of moving from the first sub-image to the second sub-image within the initial image.

In an embodiment of the method, a user cif the viewer navigating the display to the first sub-image from a third sub-image which comprises a portion of the initial image different from the first sub-image, the navigating involving an appearance of moving from the third sub-image to the first sub-image within the initial image.

In an embodiment of the method, the appearance of moving from the first sub-image to the second-image is in direction opposing the appearance of moving from the third sub-image to the first sub-image.

In an embodiment of the method, the appearance of moving from the first sub-image to the second sub-image is in a similar direction to the appearance of loving from the third sub-image to the first sub-image.

In embodiment of the method, the user navigating comprises the user touching the display.

In an embodiment method, the user navigating comprises the user moving the viewer.

In an embodiment of the method, the horizon is a line.

In an embodiment of the method, the horizon is a point.

In an embodiment of the method, the horizon comprises two intersecting lines.

In an embodiment of the method, the second sub-image is in contact with a first of the two intersecting lines and after the second sub-image is displayed, further altering the second sub-image to a third sub-image contacting both the two int erting lines, the further altering involving an appearance of moving from the second sub-image to the third sub-image within the initial image.

In an embodiment of the method, the initial image is a 2-Dimensional image.

In an embodiment of the method, the initial image comprises an image formed from a plurality of images.

In an embodiment of the method, the initial image has a field of view substantially different from the field of view of human eyesight.

In an embodiment of the method, the initial image is an image has a field of view in a hemisphere about a point.

In an embodiment of the method, the initial image is an image has a field of view in a sphere about a point.

In an embodiment of the method, the initial image is an image of an object from all points in a hemisphere about the object.

In an embodiment of the method, the initial image is an image of an object from all points in a sphere about the object.

In an embodiment of the method, the initial image is a digital image.

There is also described herein, in an embodiment, a system for assisting with navigation within an image, the system comprising; a viewer having a display; an initial image stored on the viewer; and a horizon in the initial image; wherein, the display displays a first sub-image which comprises a portion of the initial image; and wherein the display is altered from the first sub-image, to a second sub-image, the second sub-image being in contact with the horizon, the altering involving an appearance of moving from the first sub-image to the second sub-image within the initial image.

There is also described herein, in an embodiment, a system for assisting with navigation within an image, the system comprising: a viewer having a display; and computer readable media on the viewer including: an initial image in digital form; computer readable instructions for defining a horizon in the initial image; computer readable instructions for displaying on the display a first sub-image which comprises a portion of the initial image; and computer readable instructions for altering the display from the first image to display a second sub-image, the second sub-image being in contact with the horizon, the altering involving an appearance of moving from the first sub-image to the second sub-image within the initial image.

### BRIEF DESCRIPTION OF THE DRAWINGS

FIGS. 1A and 1B show a general indication of how a sub-image can be generated from navigation within a larger image,

FIG. 2 shows a photo showing a 2-D flat image of the image captured from an extreme wide angle lens with a field of view greater than 180 degrees.

FIG. 3 shows a conceptual illustration of two observer positions relative to a hemispherical image generated from an image such as that of FIG. 2.

FIGS. 4A, 4B, 4C, and 4D show various positions sub-images are selected from based on an image such as that of FIG. 3.

FIGS. 5A, 5B, 5C, and 5D show the drift direction of the position of the selected sub-image toward image grounding for the corresponding images 4A, 4B, 4C, and 4D.

FIG. 5E shows an alternative drift direction of the corresponding image 4D.

### DESCRIPTION OF THE PREFERRED EMBODIMENT(S)

This disclosure is focused on navigating within an image, particularly where the image being navigated within is of a form which has a field of view dramatically different from the field of view of standard human eyesight.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but ot limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wristwear, pendants, fabrics, and clip-on devices.

As used herein, a “computer” is necessarily an abstraction of the functionality provided by a single computer device outfitted with the hardware and accessories typical of computers in a particular role, By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality computer may be distributed across a number of individual machines. This distribution may be functional as where specific, machines perform specific tasks or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server firm, “cloud” computing system, software-as-a-service, or other distributed or collaborative computer networks.

Those of ordinary skill in the at so appreciate that some devices which are not conventionally thought of as “computers” nevertheless exhibit the characteristic “computer” in certain conexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

For purposes of this disclosure, there will also be significant discussion of a special type of computer referred to as a “mobile communication devive” or simply “mobile device”. A mobile device may be, but is not limited to, a smart phone, tablet PC, e-reader, satellite navigation system(“SatNav”), fitness device (e.g. a Fitbit™ or Jawbone™) or any other type of mobile computer whether of general or specific purpose functionality. Generally speaking, a mobile device is network-enabled and communicating with a sever system providing services over telecommunication or other infrastructure network. A mobile device essentially a mobile computer, but one which is commonly not associated with any particular location, is also commonly carried on a user's person, and usually is in near-constant real-time communication with a network allowing access to the Internet.

As will be appreciated by one skilled in the art, some aspects of the present disclosure may be embodied as a system, method or process, or computer program product Accordingly, these aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system” Furthermore, aspects of the present inventioninventimr may take the form of a computer prograt product embodied in one or more computer readable media haying computer readable program code embodied thereon.

Any combination of one or more computer readable media may be utilized. The computer readable medium may be a computer readable signal medium or a computer readable storage med n A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having: one Of more wires, a portable computer diskette, a hard disk, a random access memory (RAM), a read-only memory (ROM), an erasable programmable read-only memory (EPROM or Hash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc, or any suitable combination of the foregoing.

A computer readable signal medium may include a propagated data signal with computer readable program code embodied therein, for example, in baseband or as pan of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetoothg and other wireless communication devices, virtual memory, storage devices and associated controllers, firmware, and device drivers. The systems and methods described here are contemplated to use computers and computer software typically stored in a computer- or machine-readable storage medium or memory. The term “app” may be used to generally refer to a particular software element, of any kind, which is designed specifically to run on a mobile communication device.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in fhe art will further appreciate that the term “host” may, in noun form, refer to an endpoint of a network commun n or icatio network (e.g, “a remote host”), or may, in verb tbrni, refer to a server providing a service over a network (“hosts a website”), or an access point for a service over a network.

Throughout this disclosure, the term “real-time” refers to software operating within operational deadlines for a given event to commence or complete, or for a given module, software, or system to respond, and generally invokes that the resresponse or performance time is, in ordinary user perception and considered the technological context, effectively generally cotemporaneous with a reference event. Those, of ordinary skill in the art understand that “real-time” does not literally mean the system processes input and/or responds instantaneously, but rather that the system processe s and/or responds rapidly enough that the processing or response time is within the general human perception of the passage of time in the operational context of the program. Those of ordinary skill in the art understand that, where the operational context is a graphical user interface, “real-time” normally implies a response time of no more than one second of actual tilde, with milliseconds or microseconds being preferable. However, those of ordinary skill in the art. also understand that, under other operational contexts, a system operating “real-tide” may exhibit delays longer than one second, particularly where network operations are involved.

The present disclosure is designed to improve navigation within an image where only a portion of the image is viewed at any time on a viewing device, which is commonly a compratet display or mobile device display. The systems and methods herein are designed specifically to assist in image navigation where a user is viewing a larger image by moving through it with a sub-image being displayed on their display at any time. The selected sub-image will generally have been selected based on interpretation by a computer of a user inputting commands via, navigation controls.

Navigation within an image can occur through a variety of different mechanisms. For example, a user can scroll on a touchscreen interface to “drag” the larger image through the viewer which is usually a computer running image handling software. Similarly, a movement device such as a tlouse.touchpad, joystick, arrow keys, or similar device can be used to “move” the image or viewer relative to each other in a hardware fashion, In a still further example, the user can physically move the display in space (e.g. move the screen of a tablet computer around in a circle) to provide navigation corresponding to the viewer moving relative to the image.

Regardless of the method of navigation, it should be recognized by the reader that the discussion herein on the display of stib-images within a larger image necessarily requires some recognition that the concepts of image “navigation” discussed herein are based on human perception. Navigation is perceived as moving within the image because a human user can equate this navigation with movement they are familiar with. However, as should be apparent, navigating within a digital image presented on a computer is not physically the same as navigating a printout of the same image. It is simply perceived as the same. Thus terms such as “zoom”, “drag”, “slide”, “magnify”, etc. which are used in conjunction with a digital image correspond to a human perceiving the image to have done that motion, even though it, generally will not physically do so as the image does not physically exist in any manner. To put this another way, the systems and methods discussed herein primarily are used to virtually move through an image in a way which is perceived by a human user as corresponding to physical movement through the image and this is image navigation.

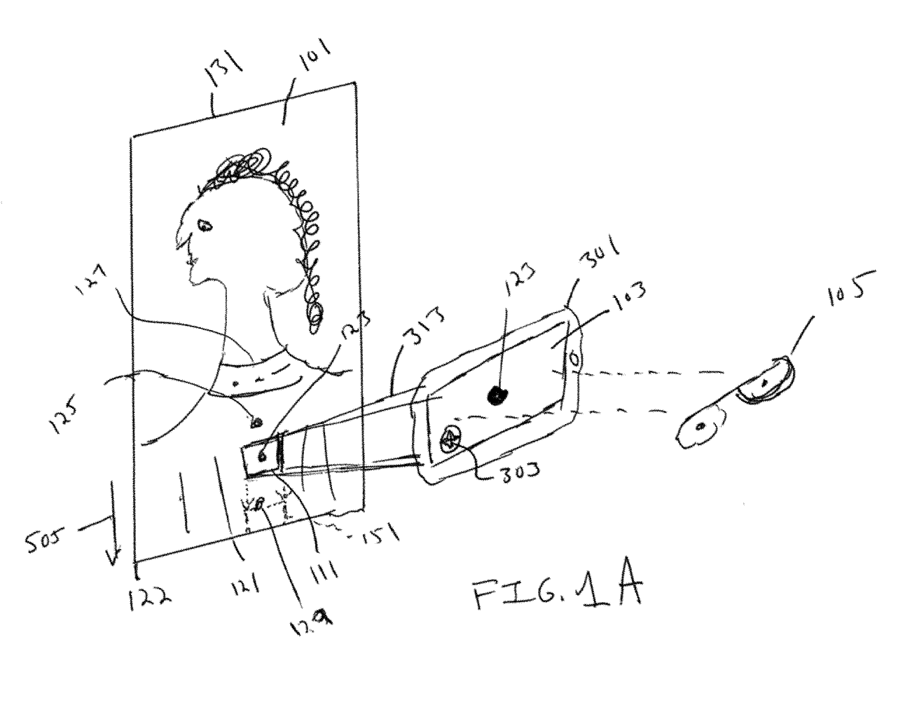

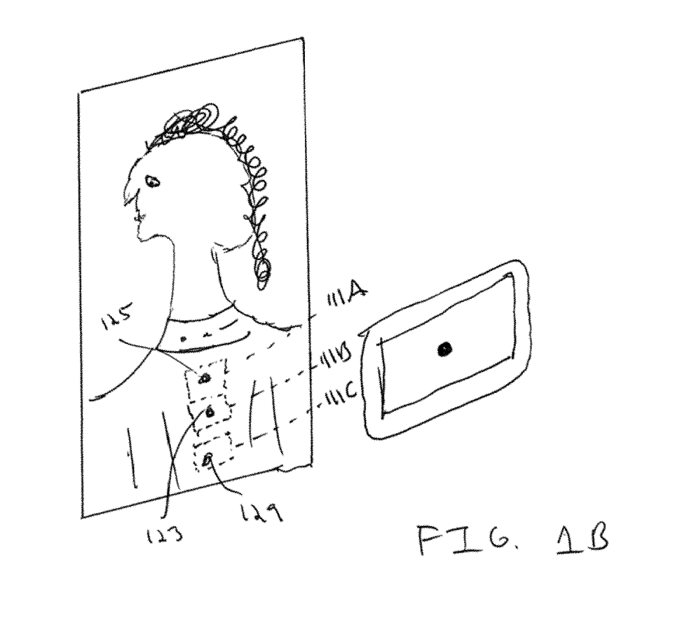

In order to understand the present case, it is important to first understand the concept of how a larger image is generally presented to a viewer via a device such as ,.a computer or mobile device. This disclosure begins with a simple 2-dimensional example as shown in FIG. 1A, In this example, there exists a larger image (101) (corresponding to a portrait in this case). It is important to recognize that the image (101) is not a thing being viewed (it is not physically present in FIG. 1A) but an image from it is displayed on the viewer (301) to the user and the user perceives it as shown in FIG. 1A. That is the image (101) is not actually present in the FIG. 1A, if a user (represented by eyes) (105) looked over the display (301), they would not see image (101), they would see nothing, but looking solely in to the viewer (301), the user (105) would perceive the display (301) to be showing a portion of the image (101) as if it was actually present.

Further, while it is indicated that image (101) is a single image, it should be recognized that based on computer operations the image (101) need not be a singular image, but may be a composite of other images, a collection of images presented as a single image for some reason, or may even comprise nothing other than code which can generate an image on the fly based on navigational input (e.g. digital animation). Further, while the image (101) is shown as static, it may be a video image and therefore could be changing over time while navigation is occurring.

The portion (111) of the image being displayed on the imager (301) is visible as sub-image (103) on the imager (301). The sub-image (103) is shown being displayed on a screen for the viewer (301) such as would be common on a tablet computer. The easiest way to think of the sub-image (103)/image (101) relationship is to contemplate “zooming” into a portion of a photo taken on a tablet computer although it should be recognized that there need not be magnification involved. The original photo is the larger image (101) while the currently displayed “zoom” portion is the sub-image (103). As can also be seen in the example of FIG. 1A, the sub-image (103) is located toward the middle of image (101) horizontally and vertically less than halfway upward from the bottom edge (121).

It is important to recognize that the larger image (101), as referenced above, generally has a specific orientation. Specifically, it generally has a recognized “up” and “down” orientation with edge (131) being the top (up) and edge (121) being the bottom (down). In the depicted embodiment, the image (101) has what would generally be considered a standard orientation based on how portraits are usually displayed. That is, they are typically displayed with the person in a. natural upright position with their head above their torso. However, it should be recognized that essentially any image (101) will generally have an orientation associated with it no matter how abstract it is and the image (101) orientation need not correspond to social norms. For example. in an alternative embodiment, edge (131) could be bottom and edge (121) the top, especially if image (101) was a particular artwork from a particular school (for example, surrealist).

The important point of recognition, however, is that basically any image, because humans live in a three dimensional world including concepts of “vertical” and “horizontal” has a definable top and bottom. For example, the image (101) may have an up and down based on the vertical orientation of the camera when it was taken (similar to the landscape vs. portrait display of a rectangular screen) or, even if completely horizontal, may have an up and down based upon the direction the camera moved immediately prior to taking it, or simply with a default based on how the camera is usually held. The key element is that any image (101) can be provided with a logical orientation and, in fact, generally is always presented with the same logical orien when viewed using imaging devices (301). Specifically, the image (101) generally has an orientation specific to the orientation of the camera taking it (and the screen (301) displaying, it) which generally does not change. Further, the top and bottom of any image may not actually correspond to an edge of the image at all. For example, down could be toward a physical horizon depicted in the image or any direction away from or toward a point. To show why this is reasonable it is logically recognized in most globes that north is up and south is down, so all points on the earth are down from the north pole and moving down will be a move closer to the south pole even though a globe may be positioned. in any orientation. Further, the poles do not correspond to edges as a sphere has no edges so one need not have an edge to have a direction. Thus, it is easy to equate the concepts of upward and downward to any selected point on the surface of a sphere, and, thus, to any position in space.

The present systems and methods relate to the navigation of sub-image (103) within the image (101) through the use of a horizon. The horizon is a line, plane, point, structure, or other thing within the navigation of the image which is generally acceptable to a human as being the downward edge of the image even if that horizon is not downward in a physical sense or an edge of the image. For example, the south pole could be a horizon, as could the north pole, equator, prime meridian, or the city of London. This disclosure primarily uses the term “toward the horizon” to avoid confusion from use of the term “downward”, however it is generally easiest to think of the horizon as being downward as this case necessarily relates to human perception.

In FIG. 1A if the user (105) wishes to alter the sub-image (103) (alter the depicted portion (103) of the larger image (101) that is on the screen (301)), the user (105) changes the sub-image (103) by navigating within the image (101) by either scrolling on their screen such as by using the navigation compass (303) which would effectively bend the lines (31.3) relative the imager (301) and move the portion (111) in that fashion, or by noving, the imager (301) around on the image (101) of FIG. 1 which keeps the lines (313) in the same position and orientation to the imager (301) but necessarily results in movement of the portion (111). Regardless of the navigation used, as the portion (111) changes, the sub-image (103) would be changing on the screen (301) pursuant to how the scroll or movement corresponds to the location within the larger image (101). For example, moving the imager (301) upward in FIG. 1A (or scrolling upward) would result in the sub-image (103) no longer displaying button (123) but instead displaying button (125) or necklace (127).

The above provides for effective navigation within the larger image (101), but it can result in conftision, particularly if the user (105) stops navigating, inadvertently moves the device (301), or hits the compass (303) unintentionally. In prior navigation. should the user utilizing the device (301) cease their navigation, the sub-image (103) would remain static. The problem with this is that multiple sub-images (103) could appear identical to a user or could lose context if information about the motion of the device (301) prior to the point shown in FIG. 1A was not known It would generally be impossible for a user presented with only the sub-image (103) to have any indication of orientation of the sub-image, position of the sub-image in the larger image, what the larger image was, or any other information relating the sub-image (103) to the image (101). This is best understood by contemplating FIG. 1A removing everything but the depiction of the sub-image (103). This is shown in FIG. 1B. In this scenario, a number of different orientations and positions of image (101) may be drawn which all could correspond to the sob-image (103) shown. For example, the sub-imag (103) could show image (111A), image (111B), or image (111C) in this scenario. Further, while the larger image (101) is depicted in the same positon in FIG. 1B and in FIG. 1A, it actually could be rotated to any angle relative to the device (301) without changing any of the above possible three images.

The present systems and methods relate to what is referred to as image grounding to assist with navigation within a larger image. Image grounding provides tbr the device (301) to alter the sub-image (103) displayed to serve to indicate to a user where they are within the larger image (101), and the orientation of the larger image (101) relative to the device (301), without them having to view the larger image (101) (or “zoom-out”). Specifically, the sub-image (103) will generally change over time by drifting toward a horizon.

In the case of FIG. 1, the horizon is selected to be the lower edge (121). Should the user cease navigation, the portion (111) being: displayed as sub-image (103) would “drift” toward the horizon, generally along the shortest vector to reach the horizon which in this case would be in the direction of the arrow (505) of FIG, 1. Once the imager (301) displays the portion (151) adjacent the horizon, the. sub-image (103) will generally cease the drift. At this time, the sub-image (103) has grounded.

As should be apparent from the above, the drift provides for two important pieces of information about the sub-image's (103) relationship to the larger image. Firstly, so long as the position of the horizon is known, the user can immediately determine the orientation of the device (301) relative to the image (101). This is because, as discussed above, the relative position of a sub-image (103) within the image (101) in this type of scenario is known subjectively from the prior position of the device (301). The drift, by providing movement of the sub-image (103) without movement of the device (301), shows the orientation of a device because the direction of drift (505) is known.

The second piece of information is that by altering the sub-imae,e (103), the user (105) can potentially see changes indicative of position as the drift occurs. For example, the user (105) would see the button (123) move off the top of their display (301) and the button (129) enter the display (301) so they know they are toward the middle of the image (101) horizontally. EVen if the user (105) can not absolutely position from the movement (e.g. they don't know if they see the progression of button (123) to button (129) or from button (.125) to button (123)), once the image is grounded and has stopped movement, the user (105) knows that the displayed sub-image (103) is along the horizon and thus, they can then scan along the horizon for a know way point, or can otherwise navigate within the image to where they expect a known waypoint to be. In the depicted embodiment, once the image has grounded, the user would know that they are looking at portion (151) and therefore the button (129) is at the top of the display (showing them the orientation of device (301) relative the, image (101)).

It should be recognized that the above contemplates the drift being toward an edge of the image (101) and the horizon being a line. In alternative embodiments, the horizon could actually be a point and the drift may occur along a first axis toward a line in line with that point and then along a second axis along the first axis. For example, once the image (103) has grounded at the lower edge 121), the image (103) may then drift to the left until it reaches the bottom left corner (122). This can provide for a much clearer indication of the potion of the viewer within the image (101). Alternatively, instead of moving along the multiple axes separately, the displayed image (103) can move along a vector directly to a horizon point namely the same corner (122). That would be diagonally toward the left corner (122).

Further, while a horizon at the bottom edge (121) of the image (101) makes sense in many cases, it is by no means required and the horizon may be any point within an image (101). For example, in image (101) the horizon could be a jewel in the necklace 127), any edge, or any other selected point, line, or other structure. Alternatively, if the image (101) vas a map of the earth, the horizon point may always be selected to correspond to the user's current OPS coordinates as shown in that map image (e,g. “You are here”)

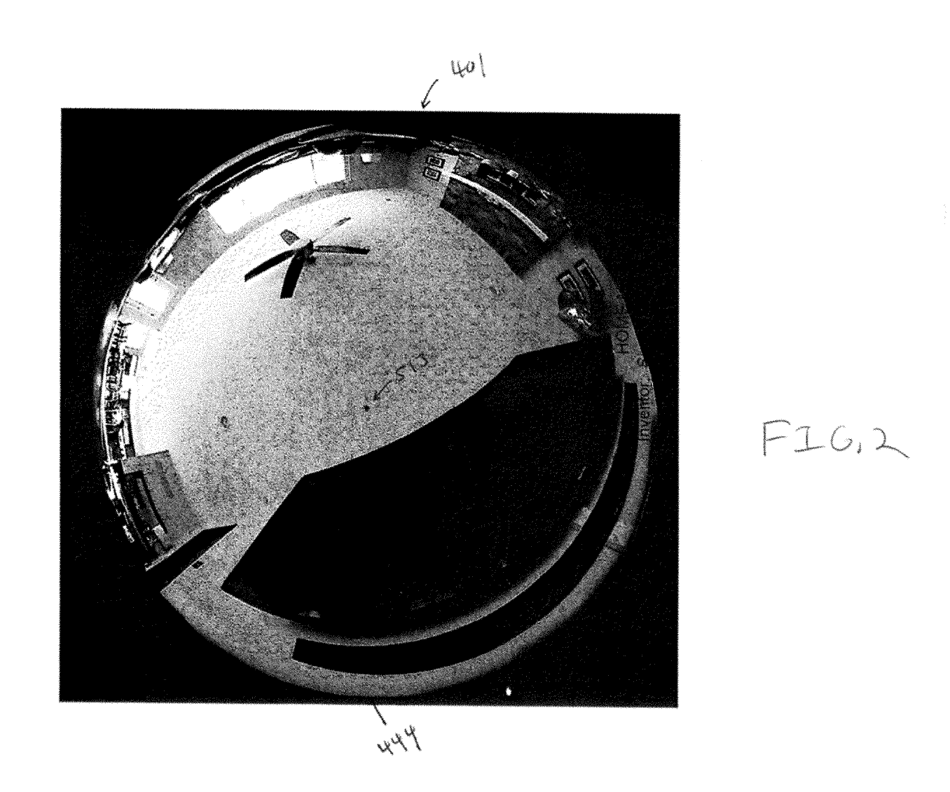

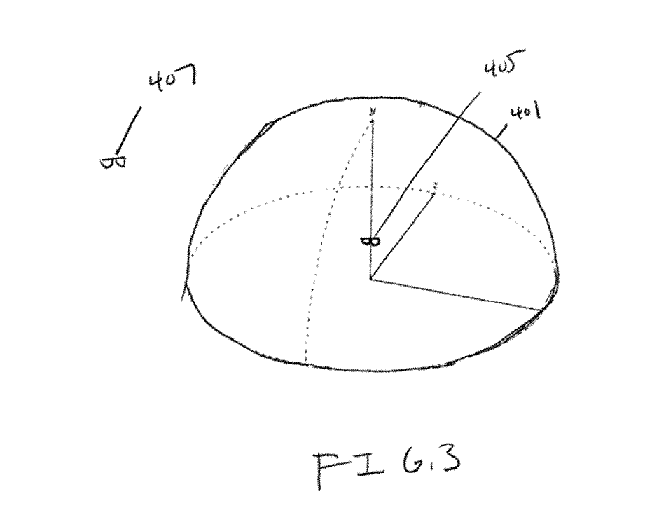

While FIG. 1 contemplates a 2-Dimensional image, the remaining FIGS. show the system at work on a 3-Dimensional image which is actually a 2D image on a 3D surface. As shown izr FIG, 3, the image (401) will generally be presented as some form of hemisphere regardless of the form of the image. This may be because the image is taken by a camera in manner such that the image actually encompasses the view of the camera around a hemisphere (e,g. it is “internal” to the hemisphere) as would be the case in conjunction with a Virtual Reality image, an image showing a three dimensional object in space, or one from a very wide angle camera, or it may be because the image is, superimposed on the hemisphere at a later time. Often it will be from a 360 degree camera or similar imaging; device. The image (401) used in these FIGS. can actually be displayed fiat as shown in FIG. 2, and the navigation can be through that 2D image, but this arrangement makes the arounding concept harder to see in the abstract due to distortion in the image (401). Thus. FIG. 3 is used instead,

The 3D image will generally be considered to be of one of two forms. In one form, the image is “internal” to a hemisphere and such an image is shown in FIG. 3 with the viewer (405) being considered inside the hemisphere image (401). Images which are in the form of “internal” to a hemisphere will generally be those where the user (405) is intended to be within an environment and the image (401) is showing the environment. They, thus, will often correspond to real world images taken in all directions (more accurately around 360 degrees) from a camera which has an unobstructed 360 view in the horizontal and/or vertical dimension. Thus, the camera will generally have a “fisheye” type lens or an array of smaller lenses to provide the wide field of view. Commonly the camera will rest flat on a horizontal surface with the camera lens aimed upward or downward. The camera will generally have at least 180 degrees of vision around the vertical axis based on the shape, of the lens or array, In alternative embodiments, it has at least 200 degrees of vision, at least 210 degrees of vision, at least 220 degrees of vision, or at least 230 degrees of vision around the vertical axis.

If the lens is aimed upward, the image seen from the lens will be centered on the point of the ceiling/sky etc. directly above the camera and the image will extend to the edges which are generally either horizontal to the ground or actually slightly below horizontal (depending of the vision arc of the lens and the position of the camera). In the depicted embodiment, the vision is generally just below the horizontal plane. This allows for the camera to be above the pound, such as placed on a table or similar object, held by a st standing user, or r mounted on a vehicle while still imaging the ground arocttrd itself. Such an image is shown in FIG. 2. The i imager can alternati e be moat ed aimed downward which still provides a very similar Malar view, however, the apex is now the floor or ground as opposed to the sky or ceiling.

This type of image is best thought of being internal to a hemisphere because the image taken by the camera effectively represents everything that can be seen by a human viewer if the human viewer vas able to see in all directions around their head at once (with their body either right side up or inverted), Basically, the viewer (405) is presented as being at the center ge (401) (the center of the heemisphere) with the image (401) surrounding them. The hemisphere also corresponds o the shape of the lens or array in 3D physical space.

The alternative formof image is one which is “external” to the hemisphere. This type of ittrage t lost commonly relates to viewing of a three dimensional object that is resting on the ground or hovering in space where a user can move around it to view it from different sides. In FIG. 3, this uses the ame I emisphereimage (401) but places the user at viewer (407). In this case, th user is mo ug around the hemisphere (401) to view it as opposed to rotating place. This type of view will commonly he provided from a moving camera which is moved around the object to visualizeit from all available sides.

It should be apparent that the difference between the two types of image relates to the relationship between the viewer and the image. In an “internal” image, the user is stationary at the center and the image is the hemisphere while in the “external” image, the image is stationary at the center and the user moves in the hemisphere. However, as can be seen in FIG. 3, the image (401) has not changed, simply the virtual position of viewer (405) or (407) has. Thus, the two, cases utilize image manipulation in effectively the same way. For ease of discussion, the remaining FIGS. use the viewer (405) and the internal hemisphere image (401) but are equally relevant to viewer (407) and an external hemisphere image.

As can be seen in FIG. 2, an internal hemisphere image (401), when viewed all at once in the field of view is highly disorienting and difficult to understand to the human eye. The present image of FIG. 2 shows an image of a room with the camera generally centered and aimed upward. Therefore, the image (401) is effectively the view of the room leaving out only the central area of the floor. This is the kind of image that may be recorded by a security system with a 360 degree view mounted on a table, for example.

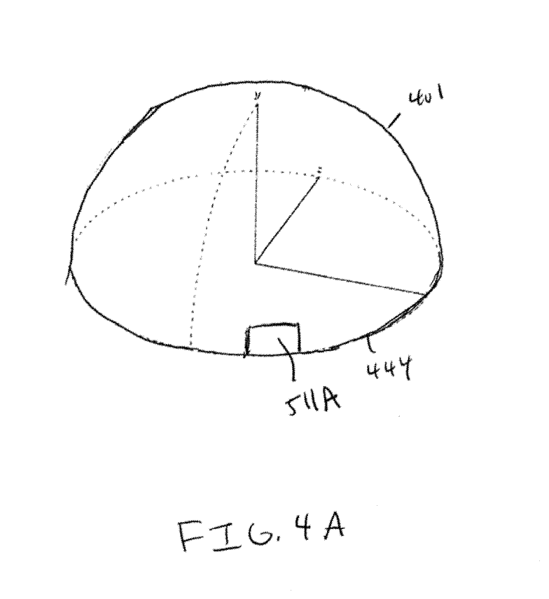

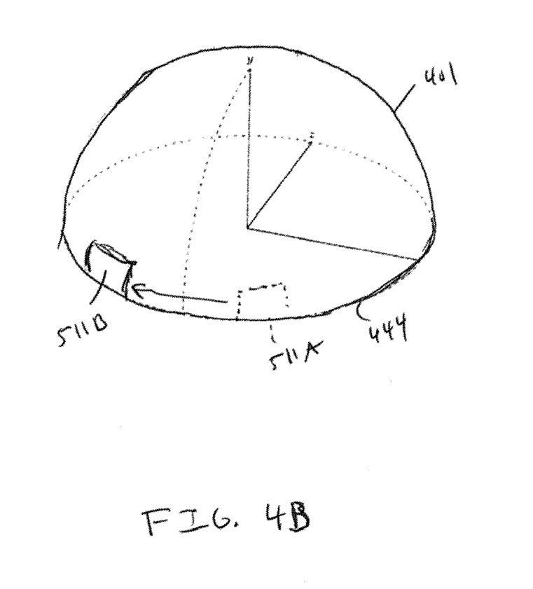

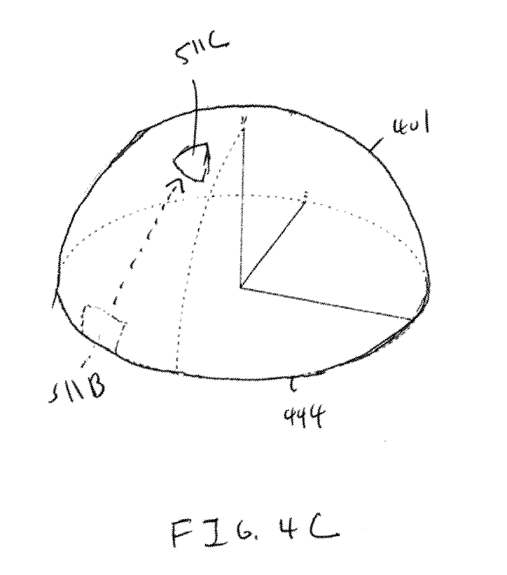

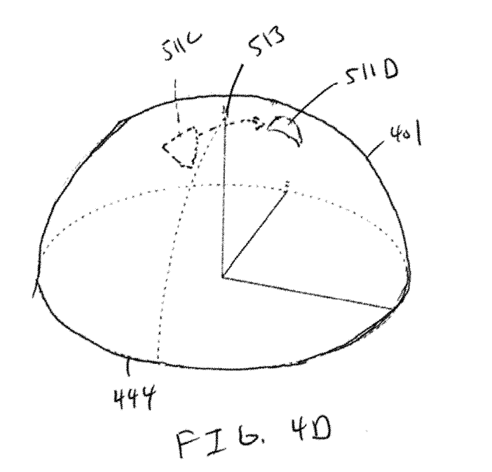

To navigate within the image (401), a user will generally position their viewer at a relevant starting location which becomes point (405) in FIG. 3 with some initial direction vector, toward the image (401), and can then move the viewer around (or scroll on the screen) up and down. As should be apparent, because of the nature of the image in FIG. 2, there is a natural horizon which is effectively the outer circumference of the circle of FIG. 2 as this generally corresponds to the position of the floor (or the lowest point of a wall that is imaged). However, the image of FIG, 2 is difficult to consider navigation as the size of the sub-image of FIG. 2 shown will often change, based on the position within it. For this reason FIGS. 4A-4D contemplate the image (401) being positioned in space as a hemisphere surrounding the user.

In FIG. 4A, the displayed portion (511A) is grounded. Further, it should be apparent that at the lower edges of the hemisphere (401), the navigation is smooth and the transition from image to image is pretty simple to follow as shown by comparing FIG. 4A to 4B. This is basically equivalent to a user slowly aiming. As such, grounding rye not be necessary in this case. Note that the movement of FIG. 4A to 4B is the equivalent of moving around the circumference of image (401) in FIG. 2.

The problem begins to become apparent by considering a portion (511C) positioned as in FIG, 4C. In FIG. 4C, the image is taken right near the apex (513) of the hemisphere image (401) (moving toward the center of FIG. 2). For one, this portion (511C) may require, different, smoothing techniques than at the edge, but more importantly, the view shown can be a little different than around the edge. However, movement from FIG. 4B to FIG. 4C is still pretty straightforward, Disorientation tends to occur if one moves from FIG. 4C to FIG. 4D where the portion (511D) has now transitioned over the apex (513). The question here is, if the image has remained free tra snioning, the sub-image (103) that would he displayed now has the top directed toward the x-z plane (as shown by the transition arrow) in FIG. 4D, as opposed toward the apex (513) as in FIGS. 4A, 4B, and 4C. In effect, the sub-image (103) that would be displayed has flipped orientation because of passing through the apex (511). in FIG. 2, this is not as apparent due to FIG. 2 not being a 3D presentation. However, once should consider that moving through the apex (513) in FIG. 2, one move first away from the floor and then toward it.

The disorientation is likely to occur because of contusion about which direction is “upward” and which is “downward” and this occurs due to the nature of the image. If one thinks about standing at the center of the hemisphere and scanning one would generally think of the lower edge (the circumference of the circle) as the lowest portion of the image as that corresponds to the floor. Similarly, the center of the circle in FIG. 2 or apex (511) of the hemisphere (401) in FIG. 3 would correspond to the highest point (the center of the ceiling). Thus, movement from the edge toward the apex would generally be thought of as upward. However, as one passes over this, the direction instantly reverses. It is the same problem as having the direction “south” go from in front of you to behind you the instant you cross the south pole.

If a human was to stand at the point (405) and move their head as the image presentation contemplated here is simulating, at the apex they have a problem, their head cannot continue to move backward without them falling over. They are therefore forced to make a physical adjustment as they go through the apex. For example, they could hold their head looking at the same point, while the turned their body 180 degrees. They could then move their head down to move downward form the apex. Thus, when using goggles, the user is forced to move their body to accommodate the physical limitation of moving through the apex in most cases. If they did not make the physical accommodation, they would be positioning their head in a way which still clearly provides for an understanding of up and dow (e.g. they would be holding their head upside down bent over backwards), even if the image is reversed from normal.

From an image presentation point of view without a headset, however, two things can happen upon crossing the apex. In a first scenario, the image can flip over on the imager as it passes through transition. This is akin to reorienting the body in the headset arrangement. The problem is that it can be disruptive to do so, and it can be disorientating because the body of the user does not necessarily move when the image flips over because the imager movement is not, tied, to the body of the user. Thus, the user may still be tilting backward, when the image suddenly rotates 180 degrees. With this situation, a viewer looking at the stab-image after rotation only may not know how to navigate within the image to return from FIGS. 4D to 4C as the movement of the imager will now be backward to the movement of the image when compared to immediately prior movement. It can be particularly problematic in a situation where the area around these images has few features because it depicted the sky or a room's

The alternative is not to adjust the image and simply keep it oriented as before with upward being in the direction of the arrow in FIG. 411 This presents the alternative problem that a user may reorient their body without reorienting the device. Should they do so, the device is again moving backwards as having passed over the apex the image is now upside down when viewed by the user who has altered their physical position. As should be apparent. FIGS. 4C and 4D include no indication of the body of the user, so how the image should be oriented is unclear.

It should be apparent from the above that the problem is principally created because when the device (301) is used to navigate within a larger image and the device can be moved outside of movement of the user's body, any disconnect between the device movement and the body movement can result in a “reversal” of the displayed sub-image (103) relative to the body position of the user.

As discussed above in the 2D example, image grounding seeks to return the user to an artificial horizon, which generally would correspond to a logical position or to an edge or center of the entire image. These types of points are generally intended to provide for ready understanding of location and reorientation.

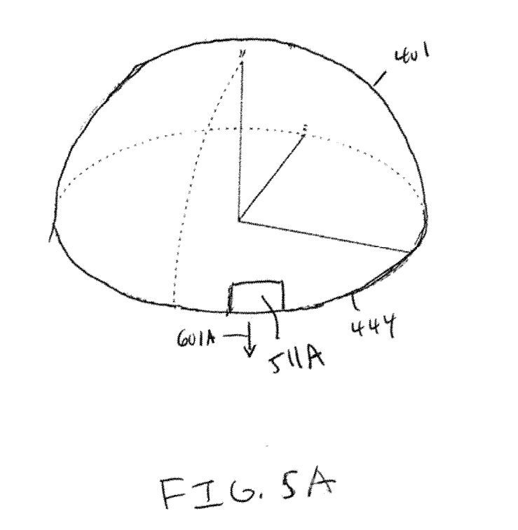

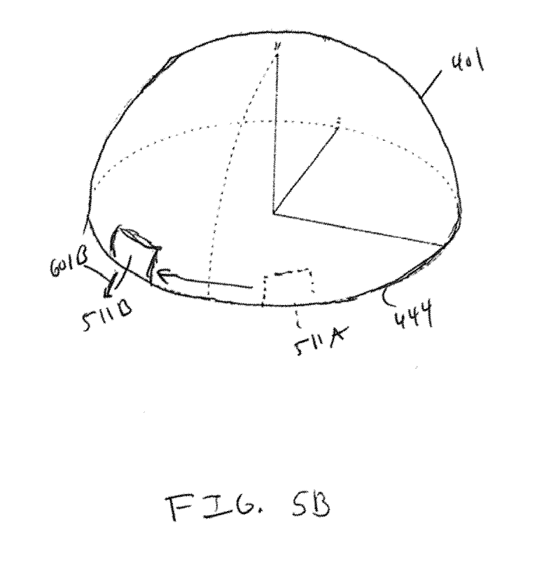

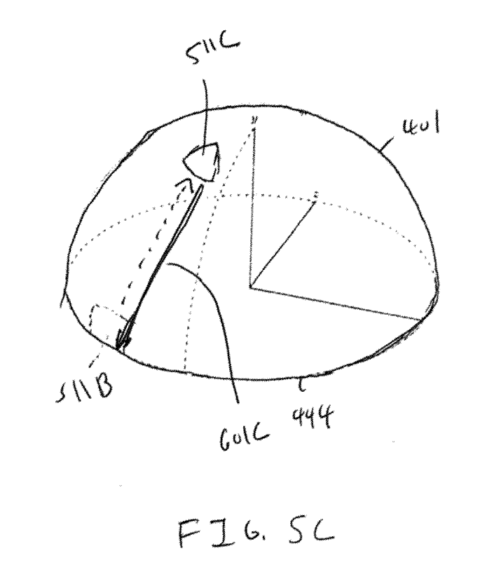

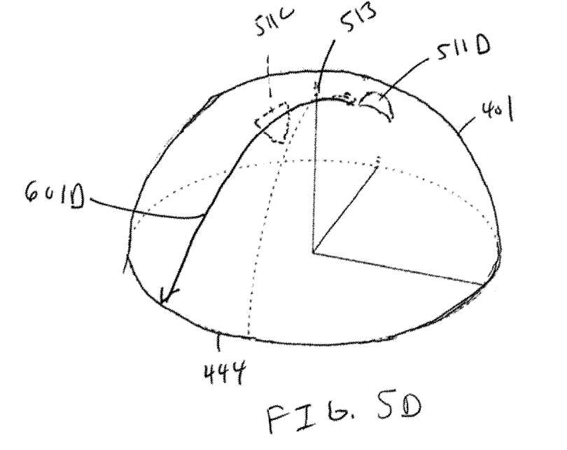

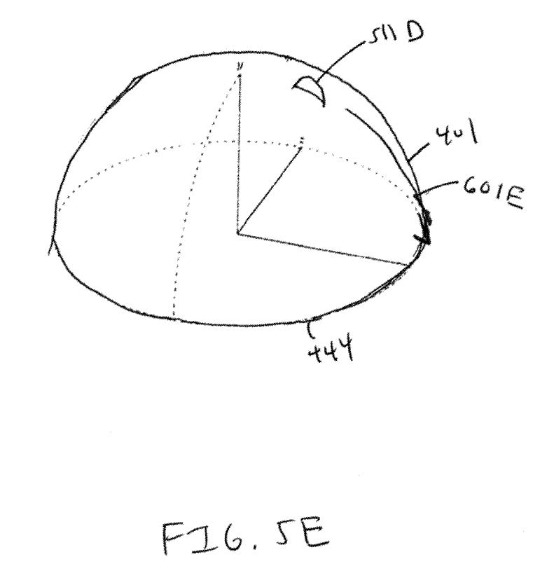

FIGS. 5A -5D contemplate the shifting of the image in a grounding scenario and relate to the original images of FIGS. 4A 4D. In these figures, the selected horizon is the circumference (444) of the image (401) which, as discussed in conjunction with a figure such as that shown as FIG. 2, would correspond to the floor of a structure. With an internal image, this is a very logical grounding point as in most “internal” hemisphere images, the circumference will be the ground or floor of the image presented as the ground blocks a view below it. In FIGS. 5A and 5B, the user is already viewing at the horizon, so no movement or grounding will happen, because the user is already grounded and the drift arrows (601A) and (601B) that show the pattern of drift are off the image therefore meaning there is no drift. As can be seen in FIG. 5C, in this situation, the grounding serves to move the image along a radius and toward the edge or along drift arrow (601C). It is important to note that the movement corresponds to the “down” direction not based on the orientation of the device (301) or user (405), but based on the orientation of the movement within the image. Specifically, the drift arrow (601C) is directly opposed to the movement from FIG. 4B to FIG. 4C.

FIG. 5D illustrates a meaning. of “downward” In this case the imiver has rolled over the apex and continued until the position of FIG. 5. in this case, while it has to technically move upward first, the direction of the drift arrow (601D) is still to move opposite the direction moved of the image between FIG. 4C and FIG. 4D and theretbre the opposite of the prior relative upward movement of the imager from FIGS. 4B, to 4C, to 4D (which is intended to essentially be linear). That is, the user was consistently moving the imager up (the direction of the arrow) prior to ceasing navigation. Thus, down is the opposing direction.

Alternatively, one can have FIG. 5E. FIG, 5E has no corresponding prior FIG. to show movement, but the image is the same position (511D) as in FIGS. 5D and 4D. FIG SE is to illustrate that it is possible for it to be unknown or irrelevant how the image (511D) was navigated to this point. Given this, the image may drift along drift arrow (601E). Effectively, either drift arrow (601D) or (601E) may be used from the position of either FIG. 3D or FIG. 5E (both corresponding to FIG, 4D).

In the event of FIG. 5E, there are a couple of options to select between drift arrow (601E) or (601D). In one, option, the image may simply be along drift arrow (601E) with no change in orientation of the sub-linage (103) as viewed on, display (301) regardless of the orientation of the device (301) in the physical universe (or if the physical orientation is unknown). In an alternative embodiment, the current orientation of the device (301) may be determined and the drift arrow (601D) will be selected if this would move the image toward downward with respect to the current physical orientation of the device (301). Similarly, drift arrow (601E) would be selected if this has the result of moving the image toward downward with respect to the current physical orientation of the device (301). In a final embodiment, drift arrow (601E) may be selected even if the current orientation of the device (301) made this upward, but the sub-image (103) may be rotated on the display (301) as part of the drift to reorient the sub-image (103) to the physical orientation of the device (301).

As the image grounds out moving toward the horizon (e.g. towards the arrangement of FIGS. 5A and 5B), the user can see which direction on the imager is currently “up” based on the direction of drift (which is “down”). Once the image grounds out, the orientation can be determined as moving the physical device toward the horizon (along a drift arrow) will generally not result in the sub-image changing, while moving in other directions will. This allows for a user who has a device in a physically difficult position at the time of grounding out, to move the device to a better position without having to wait for the image to ground out again. For example, if the device is held at arms length virtually straight up, the user can move the device physically lower in the direction of the prior drift without the sub-image changing. Generally, the image will remain grounded until the user moves the device or otherwise indicates navigation. in a direction other than the direction of drift. Alternatively, the image may not move from the grounded image until the user positions the device either over a hypothetical positon corresponding to the position of the displayed sub-image based on the initial positioning of the device prior to navigation.

It should be recognized that a benefit of the grounding as a specific motion toward an artificial and identifiable horizon is that generally, as the image moves towards the horizon, the orientation of the device within the image becomes more apparent. This means that the user can generally rapidly determine how the device is oriented within the image regardless of how it was oriented. Further, upon grounding, the general location of the device within the image can also often be determined.

In an embodiment, after grounding, the device may specifically allow for the user to reorient it as they would prefer before resuming navigation. For example, it may allow them to rotate the device and rotate the image simultaneously immediately after grounding, even if normally the reorientation would actually, result in the device moving within the image. Thus, should the image appear upside down to the user, they can flip the device over which would normally not work as the image would change as the device was rotated.

The reorientation to ground the image can occur at any time or under any circumstances. In an embodiment, it will occur automatically when the device detects that navigation has not occurred for a period of time, for example 1 second, 2 seconds, or 5 seconds. While the lack of navigation is generally a preferred trigger, it is not required and in an alternative embodiment the system can ground upon request of the user, or can always try to ground (e.g. the user has to be actively moving away from the ground) depending on user preference.

The qualifier “generally,” and similar qualifiers as used in the present case, would be understood by one of ordinary skill in the art to accommodate recognizable. attempts to conform a device to the qualified term, which may nevertheless fall short of doing So. This is because terms such as “planar” are purely geometric constructs and no real-world component is a true “plane” in the geometric sense. Variations from geometric and mathematical descriptions are unavoidable due to, among other things, manufacturing tolerances resulting in shape variations, defects and imperfections, on-tirlifOrtri thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a ranee of variations from the literal geometric meaning of the term in view of these and other considerations.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of, the present disclosure can be used interchangea bly with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

1. A method for assisting with navigation within an image, the method comprising:
providing a viewer having a display;
providing an initial image;
defining a horizon in said initial image:
displaying on said display a first sub-image which comprises a portion of said initial image, and
from said first sub-image, altering said display to display a second sub-image, said second sub-image being in contact with said horizon, said altering involving an appearance at moving from said first sub-image to said second sub-image within said initial image.

2. The method of claim 1, wherein a user of said viewer navigating said display to said first sub-image from a third sub-image which comprises a portion of said initial image different from said first sub-image, said navigating involving an appearance of moving from said third sub-image to said first sub-image within said initial image.

3. The method of claim 2, wherein said appearance of moving from said first sub-image to said second sub-image is in a direction opposing said appearance of moving from said third sub-image to said first sub-image.

4. The method of claim 2, wherein said appearance of moving from said first sub-image to said second sub-image is in a similar direction to said appearance of moving from said third sub-image to said first sub-image.

5. The method of claim 2, wherein said user navigating comprises said user touching said display.

6. The method of claim 2, wherein said user navigating comprises said user moving said viewer.

7. The method of claim 1, wherein said horizon is a line.

8. The method of claim 1, wherein said horizon is a point.

9. The method of claim 1, wherein said horizon comprises two intersecting lines.

10. The method of claim 9, wherein said second sub-image is in contact with a first of said two intersecting lines and after said second sub-image is displayed, further altering said second sub-image to a third sub-image contacting both said two intersecting lines, said further altering involving an appearance of moving from said second sub-image to said third sub-image within said initial image.

11. The method of claim 1, wherein said initial image is a 2-Dimensional images.

12. The method of claim 1, wherein said initial image comprises an image formed from a plurality of images.

13. The method of claim 1, wherein said initial image has a field of view substantially different from the field of view of human eyesight.

14. The method of claim 9, wherein said initial image is an image has a field of view in a hemisphere about a point.

15. The method of claim 9, wherein said initial image is an image has a field of view in a sphere about a point.

16. The method of claim 9, wherein said initial image is an image of an object from all points in a hemisphere about said object.

17. The method of claim 9, wherein said initial image is an image of an object from all points in a sphere about said object.

18. The method of claim 1, wherein said initial image is a digital image.

19. A system for assisting with navigation within an image, the system comprising:
a viewer having a display;
an initial image stored on said viewer; and
a horizon in said initial image,
wherein, said display displays a first sub-image which comprises a portion of said initial image, and
wherein said display is altered from said first sub-image, to a second sub-image, said second sub-image being in contact with said horizon, said altering involving an appearance at moving from said first sub-image to said second sub-image within said initial image.

20. A system for assisting, with navigation within an image, the system comprising:
a viewer having a display; and
computer readable media on said viewer including:
an initial image in digital form;
computer readable instructions for defining a horizon in said initial image;
computer readable instructions for displaying on said display a first sub-image which comprises a portion of said initial image; and
computer readable instructions for altering said display from said first image to display a second sub-image, said second sub-image being in contact with said horizon, said altering involving an appearance of moving from said first sub-image to said second sub-image within said initial image.
